(19) United States
(12) Patent Application Publication
(10) Pub. No.: US 2020/0319855 A1
(43) Pub. Date: Oct. 8, 2020

(54) PARAMETER MODIFICATION OF VIRTUAL ENTITIES FOR CLIENT APPLICATIONS

(71) Applicant: MZ IP HOLDINGS, LLC, Palo Alto, CA (US)

(72) Inventors: John R. Geraci, San Jose, CA (US); Douglas A. Hill, Cupertino, CA (US)

(21) Appl. No.: 16/828,092

(22) Filed: Mar. 24, 2020

Related U.S. Application Data
(60) Provisional application No. 62/827,943, filed on Apr. 2, 2019.

(51) Int. Cl. G06F 8/33; G06F 9/455; G06F 11/36

(52) U.S. Cl. CPC G06F 8/33; G06F 2009/45591; G06F 11/3664; G06F 9/45558

(57) ABSTRACT

Augmenting parameters are received for one or more default parameters of a virtual entity of one or more client applications. The augmenting parameters are applied to the one or more default parameters to generate a modified set of parameters for the virtual entity. The modified set of parameters are provided to the one or more client applications comprising the virtual entity, wherein the virtual entity is modified based on the modified set of parameters while the one or more client applications is running.

### CROSS-REFERENCE TO RELATED APPLICATIONS

This application claims the benefit of U.S. Provisional Patent Application No. 62/827,943, filed Apr. 2, 2019, the entire contents of which are incorporated by reference herein.

### BACKGROUND

Client applications, particularly games, often employ the concept of virtual entities, in which the software instantiates, retires or maintains some set of virtual entities that together form the software experience. For example, in a gaming application, the player can encounter virtual entities such as heroes, monsters, animals, etc. In the client application, the virtual entities may have different associated parameters. For example, a hero of a gaming application might have 500 hit points, while a monster might have 100 hit points. These parameters associated with the virtual entities are hard-coded in a scripting language of the client application.

### DESCRIPTION OF THE DRAWINGS

FIG. 1 is a schematic diagram of an example augmenting parameter system for augmenting parameters of virtual entities of a client application.

FIG. 2 is an illustration of an example of entity data for an entity to be utilized by one or more client applications, in accordance with embodiments of the disclosure.

FIG. 3 is an illustration of an example of receiving augmenting parameters for entity data, in accordance with embodiments of the disclosure.

FIG. 4 is an illustration of an example of generating a set of modified parameters for entity data, in accordance with embodiments of the disclosure.

FIG. 5 is an illustration of an example of a user interface for receiving augmenting parameters for modifying an entity, in accordance with embodiments of the disclosure.

FIG. 6 is an illustration of an example of a simulation of a virtual environment of a client application, in accordance with embodiments of the disclosure.

FIG. 7 is an illustration of an example of a graphical representation of statistics acquired from a simulation of a client application, in accordance with embodiments of the disclosure.

FIG. 8 is a block diagram illustrating an example method of utilizing augmenting parameters to modify an entity of one or more client applications, in accordance with embodiments of the disclosure.

FIG. 9 is a block diagram of an example computing device.

### DETAILED DESCRIPTION

Aspects of the disclosure relate to parameter modification of virtual entities for client applications. The client application may include various virtual entities (also referred to as “entities” hereafter). Entities may correspond to any unit/object represented within the client application (also referred to as “application” hereafter). For example, in a video game application, an entity may be a hero, a monster, a chest, etc. instantiated within a virtual environment of the video game application.

In a conventional client application, each time an entity is to be modified, the source code of the entity must be accessed and changed. For example, if a developer wishes to modify the health parameter of an entity, the developer must access the source code (also referred to as “code” hereafter) for the entity, identify the particular script within the code that corresponds to the health parameter, and make the desired change. Accordingly, making modifications to an entity of the client application requires a developer to have intricate knowledge of the underlying source code to make these modifications to each entity. Such a process is tedious, inefficient, and may introduce errors into the client application resulting from the modification of the code of the client application. Furthermore, because the source code of the application is being modified, the modifications to the entity cannot be made or will not take effect while the client application is running.

Aspects of the disclosure remedy the above and other deficiencies by applying augmenting parameters to entities of one or more client applications. A parameter may be any property associated with an entity of a client application. For example, in a video game application, parameters of an entity may include hit points (HP), speed, attack power, defense, abilities, etc. associated with the entity. Each entity may include a set of default parameters that may act as a baseline for the augmenting parameters. For example, in a video game application, a knight may have default parameters indicating the knight has 400 HP, 75 speed, 100 attack, and 200 defense.

The processing logic may receive augmenting parameters for one or more default parameters of an entity. In embodiments, an augmenting parameter may be any modification of a default parameter of an entity. For example, an augmenting parameter may modify the HP of a knight from 400 HP to 500 HP. In some embodiments, an augmenting parameter may be a new parameter to be added to the default parameters. For example, an augmenting parameter may be a new parameter that grants the knight a healing ability.

In embodiments, the augmenting parameters may be provided via a simple script or user interface provided to a user. For example, if a user wanted to modify a knight entity, the user may enter/select an augmenting parameter to be applied to default parameters of a knight. The default and augmenting parameters may be linked to the properties/behaviors written in the underlying source code of the client application(s). For example, an augmenting parameter that adds a healing ability to an entity may be linked/mapped to the underlying source code of the client application(s) that enables the performance of the healing ability by an entity. The result is the ability for a user with little to no knowledge of the source code of a client application to modify parameters of entities used by the client application(s). This also prevents a user from having to modify the source code of a client application to modify the entity, preventing the introduction of any errors that may be produced by such modifications. Additionally, parameters may be linked to underlying source code of any number of client applications utilizing any number of different programming languages, providing an application agnostic process for modifying parameters of entities.

The processing logic may apply the augmenting parameters to the one or more default parameters to generate a set of modified parameters for the virtual entity. For example, if the augmenting parameter was to change the HP of a knight from 400 to 500, the processing logic may generate a set of modified parameters in which the knight has an HP value of 500.

The processing logic may provide the modified set of parameters to the one or more client applications that include the virtual entity. For example, in a video game application, the processing logic may provide a modified set of parameters of a knight entity to one or more client applications that include the knight entity. The virtual entity may then be modified at the one or more client applications based on the modified set of parameters. Because the underlying source code of the client application has not been changed, the modification of the virtual entity in the client application(s) may be done without requiring the client application(s) to be restarted (e.g., while the client application(s) are running).

By utilizing augmenting parameters, entities may be modified by users that do not have knowledge for the underlying source code of client application(s) and prevents such users from having to modify the source code of the client application(s) and potentially introducing errors into the source code from the modifications. Furthermore, the augmenting parameters may be linked to underlying source code of any number of client applications utilizing any number of programming languages, allowing for the modification of entities across any number of client applications utilizing any number of programming languages.

Although examples of the disclosure may be described in the context of a video game application, such examples are for illustrative purposes only. Aspects of the disclosure may be utilized by any client applications that use any kind of modeling environment and/or entities. For example, aspects of the disclosure may be used by architectural modeling software to modify architectural features, furniture, designs, etc. In another example, aspects of the disclosure may be used by computer animation and/or video editing software to efficiently modify entities between frames/scenes of a video. In a further example, aspects of the disclosure may be utilized by a mapping/navigation application to efficiently modify entities such as gas stations, restaurants, grocery stores, etc.

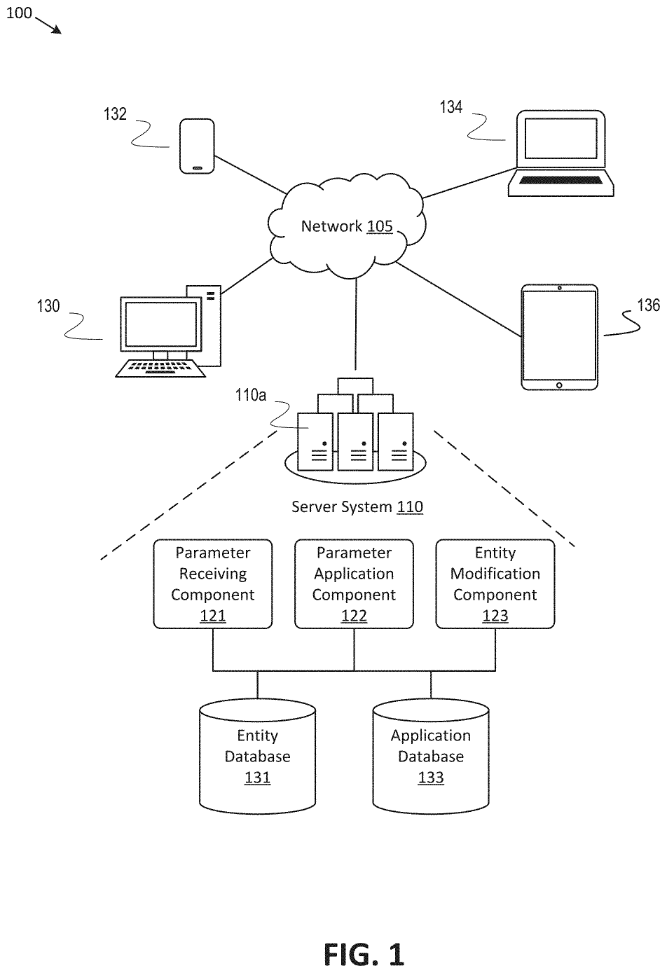

FIG. 1 is a schematic diagram of an example augmenting parameter system 100 for applying augmenting parameters to modify entities of one or more client applications. A server system 110 including one or more servers 110a provides functionality for operating and managing an online application used by users via client devices 130-136, including installs of an online application (e.g., mobile application, gaming application, mobile gaming application), facilitating user interactions, introducing features, and any other suitable operation. The server system 110 includes software components and databases that can be deployed at one or more data centers in one or more geographic locations. In certain instances, the server system 110 is, includes, or utilizes a content delivery network (CDN). The server system 110 may include one or more software components, including a parameter receiving component 121, a parameter application component 122, an entity modification component 123, and any other suitable component for fulfilling the methods discussed herein. The software components can include subcomponents that can execute on the same or on different individual data processing apparatus. The server system 110 databases can include an entity database 131 and an application database 133, and any suitable number of other databases that are not illustrated in FIG. 1, such as a features database, a payments database, or an authentication database. The databases can reside in one or more physical storage systems. The software components and data will be further described below.

A client application, such as a web-based application, can be provided as an end-user application to allow users to interact with the server system 110 and with other users of the server system 110 via the application. The client application or components thereof can be accessed through a network 105 (e.g., the Internet) by users of client devices, such as a personal computer 130, a smart phone 132, a laptop computer 134, or a tablet computer 136. Other client devices are possible. Additionally, or alternatively, software components for the system 100 (e.g., the parameter receiving component 121, the parameter application component 122, the entity modification component 123) or any portions thereof can reside on or be used to perform operations on one or more client devices.

The augmenting parameter system 100 includes the parameter receiving component 121, the parameter application component 122, and the entity modification component 123 as being able to communicate with the entity database 131 and the application database 133. The entity database 131 may include one or more data structures storing one or more entities and their associated parameters for use by one or more client applications by the augmenting parameter system 100, such as default parameters, augmenting parameters, entity types, entity names, key values, etc. of the virtual entities. The application database 133 may include information about one or more client applications utilizing the entities of the augmenting parameter system 100. Such information may include client application identifiers, addresses, programming languages, linking/mapping information to underlying source code of the client application(s), and/or any other suitable information.

The parameter receiving component 121 may be responsible for receiving default parameters and/or augmenting parameters for entities. The parameter receiving component 121 may be implemented by one or more human operators, or may be implemented as a machine-learning model that automatically performs one or more of the actions discussed herein. In embodiments, the parameter receiving component 121 may generate a simple script or user interface and provide the script/user interface to a user to facilitate the generation of the augmenting parameters. For example, the parameter receiving component 121 may generate a user interface that includes a listing of the default parameters of an entity and provide the user interface to a client device of a user. The parameter receiving component 121 may receive the augmenting parameters as modifications to the default parameters of an entity that are entered/selected by the user via the user interface.

The parameter application component 122 may be responsible for applying augmenting parameters received by parameter receiving component 121. The parameter application component 122 may receive one or more augmenting parameters from the parameter receiving component 121 that are to be applied to the default parameters of an entity. For example, the parameter application component 122 may receive an augmenting parameter corresponding to an increased attack value to be applied to the default parameters of a knight entity. The parameter application component 122 may identify the default parameters stored in a data structure at the entity database 131. For example, the parameter application component 122 may identify the default parameters for a knight entity within the data structure. Upon identifying the default parameters, the parameter application component 122 may apply the augmenting parameters to the default parameters to generate a modified set of parameters for the entity. For example, the parameter application component 122 may apply the augmenting parameter of an increased attack value by overriding the default attack value parameter of a knight entity to generate a modified set of parameters that includes the modifications made by the augmenting parameter. In embodiments, the parameter application component 122 may store the augmenting parameters and/or the modified set of parameters in the data structure at entity database 131. In some embodiments, the parameter application component 122 may generate a new data file that includes the augmenting parameters and/or the modified entity.

The entity modification component 123 may be responsible for providing the modified set of parameters generated by the parameter application component 122 to one or more client applications. As previously described, the parameters of an entity may be linked/mapped to underlying source code/data files of the client application(s). In embodiments, the entity modification component 123 may identify the mapping information for the underlying source code/data files in the application database 133. For example, the entity modification component 123 may identify mapping information for the underlying source code that controls the attack power of an entity based on receiving an augmenting parameter corresponding to a modification of attack power of the entity. In some embodiments, the mapping information may include one or more data files or other internal reference/identifier used by the client application(s) that correspond to the override parameter.

The entity modification component 123 may cause one or more client applications to modify the corresponding entity associated with the modified set of parameters. In embodiments, the entity modification component 123 may transmit a command to the one or more client applications to cause the modification of the entity. The command may include information identifying the underlying source code/data files corresponding to the parameters associated with the entity to be modified by the modified set of parameters. Upon receipt of the command, the one or more client applications may modify the entities while the one or more client applications are running. For example, upon receipt of the command a video game application may modify the entity within a virtual environment of the video game application while the video game application is running (e.g., without requiring a restart of the application).

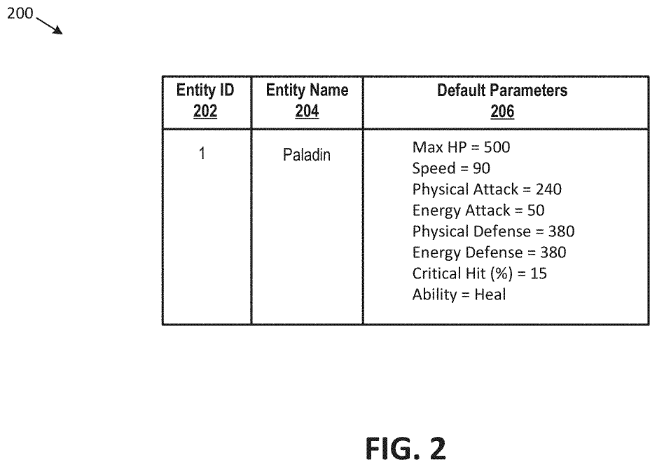

FIG. 2 is an illustration of an example of entity data 200 for an entity to be utilized by one or more client applications, in accordance with embodiments of the disclosure. In embodiments, entity data 200 may correspond to an entry in a data structure that includes a listing of one or more entities for use by the one or more client applications, as previously described. In some embodiments, entity data 200 may correspond to a data file for an entity.

Referring to FIG. 2, entity data 200 may include an entity identification (ID) 202, an entity name 204, and default parameters 206. The entity ID 202 may correspond to a reference/identification for the entity associated with entity data 200. The entity ID 202 may be a number, a series of alphanumeric characters, or any other type of reference/identification. In embodiments, entity ID 202 may correspond to a key value of a key value store. In some embodiments, the entity ID 202 may be utilized for internal representation by client application(s) and/or cross-referencing between different entities. For example, in a video game application, a room entity might include entity ID 202 (e.g., 1) to indicate that the room is to have a dragon inside of it. The entity name 204 may be a name that is assigned to a particular entity. The entity name 204 may be specified to be provided to a user and be more human-friendly.

Default parameters 206 may correspond to parameters of the entity associated with entity data 200. For example, default parameters 206 may correspond to the default parameters for a paladin entity within a video game application. Default parameters 206 are shown in a simple script format that includes a listing of the default parameters for a paladin entity. For example, a paladin entity may be named “Paladin,” have a maximum HP of 500, a speed of 90, a physical attack of 240, an energy attack of 50, a physical defense of 380, an energy defense of 380, a critical hit percentage of 15 and a healing ability. As previously described, the default parameters 206 may be mapped/linked to underlying code/data files of one or more client applications.

It should be noted that entity ID 202, entity name 204, and default parameters 206 are shown for illustrative purposes only. In embodiments, entity data 200 may include any combination of entity ID 202, entity name 204, default parameters 208 and/or any other information associated with an entity.

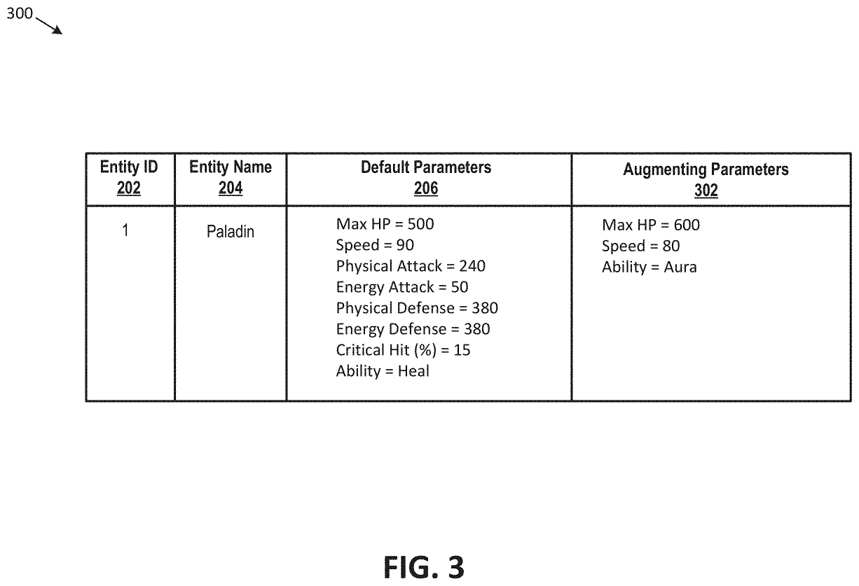

FIG. 3 is an illustration of an example of receiving augmenting parameters for entity data 300, in accordance with embodiments of the disclosure. Entity data 300 may include augmenting parameters 302 that are to be applied to the default parameters 206 of an entity of entity data 300. The entity data 300 may include entity ID 202, entity name 204, and default parameters 206, as previously described at FIG. 2. The augmenting parameters 302 may correspond to parameters that override the default parameters 206 of the entity. For example, the augmenting parameters 302 may each override the corresponding parameters in the default parameters 206. In embodiments, the augmenting parameters 302 may be received from a user/developer of one or more client applications. In some embodiments, the augmenting parameters 302 may be determined automatically by processing logic of a computer processing device. For example, the augmenting parameters may be determined by a machine learning algorithm.

Referring to FIG. 3, the entity data 300 includes augmenting parameters 302 to modify multiple parameters of the paladin entity. In FIG. 3, the augmenting parameters 302 increase the max HP of the paladin entity from 500 to 600 and decrease the speed of the paladin entity from 90 to 80. If one of the default parameters 206 does not have a corresponding augmenting parameter 302, then the default parameter 206 may remain unchanged. For example, the physical attack, energy attack, physical defense, energy defense, and critical hit percentage of the default parameters 206 may remain unchanged because they do not have corresponding augmenting parameters 302, as will be described in further detail below.

In some embodiments, augmenting parameters 308 may include a new parameter to be added to the default parameters 206 when modifying the entity. A new parameter may be any parameter not included in the default parameters 206 for an entity. For example, augmenting parameters 302 add a new parameter (e.g., an aura ability) to the paladin entity.

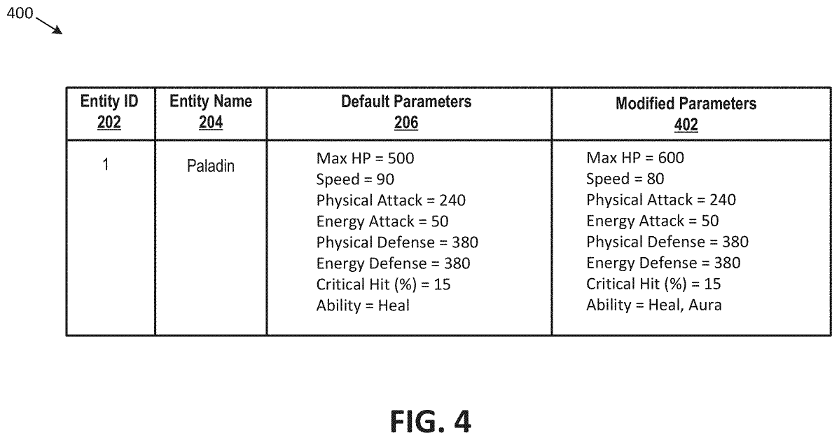

FIG. 4 is an illustration of an example of generating a set of modified parameters for entity data 400, in accordance with embodiments of the disclosure. The entity data 300 may include entity ID 202, entity name 204, and default parameters 206, as previously described at FIG. 2.

Referring to FIG. 4, the entity data 400 includes modified parameters 402 that correspond to a modified set of parameters for a paladin entity. The modified parameters 402 may be generated by applying the augmenting parameters 302 of FIG. 3 to the default parameters 206 of the paladin entity. For example, the augmenting parameters may be applied to default parameters 206 to generate modified parameters 402 that include the increase of maximum HP to 600, the decrease of speed to 80, and the addition of the aura ability to the paladin entity. Upon generating the modified parameters 402, the modified parameters 402 may be provided to one or more client applications that utilize the entity associated with the modified parameters 402. For example, the modified parameters 402 may be provided to one or more client applications that utilize the paladin entity. Providing the modified parameters 402 to the one or more client applications may cause the one or more client applications to modify parameters of the entity in accordance with the modified parameters 402. For example, the one or more client applications may modify any paladin entities within the one or more client applications to increase the maximum HP to 600, the decrease of speed to 80, and the addition of the aura ability to paladin entities.

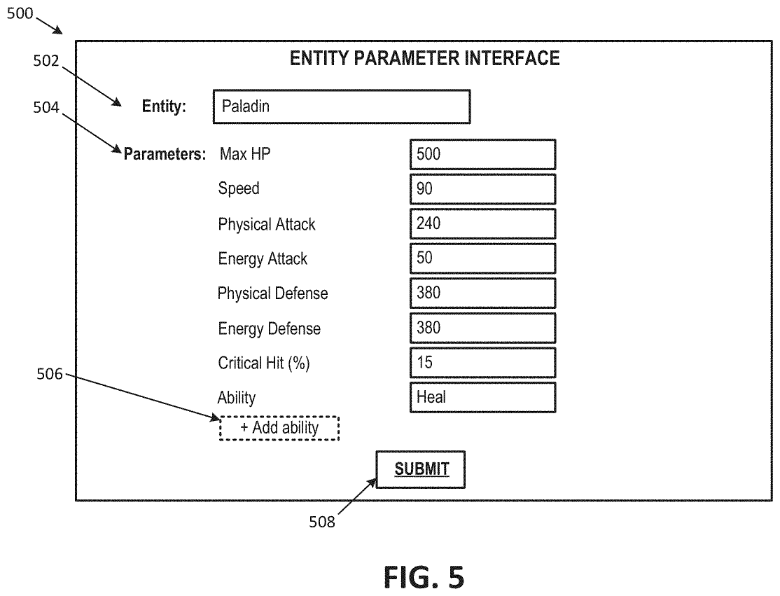

FIG. 5 is an illustration of an example of a user interface 500 for receiving augmenting parameters for modifying an entity, in accordance with embodiments of the disclosure. As previously described, in some embodiments the augmenting parameter system may provide a user interface 500 to a user to facilitate the entry of one or more augmenting parameters to be used for the modification of an entity. In some embodiments, the user interface 500 may be a graphical user interface (GUI). In embodiments, the user interface 500 may be provided to a client device associated with the user.

The user interface 500 may include an entity 502 identification, parameters 504 associated with the entity, an add parameter 506 option and a submission icon 508. When providing augmenting parameters to be used to generate a modified set of parameters, a user may either enter an existing entity 502 or select an entity 502 from a listing of existing entities via the user interface 500. Upon entering/selecting an entity 502, the parameters 504 portion of the user interface 500 may be populated with the default parameters (e.g., default parameters 206 of FIG. 2) for the entered/selected entity 502. For example, upon selecting the paladin entity, the parameters 504 portion of the user interface 500 may be populated with the default parameters of the paladin archetype.

In some embodiments, a user may enter the augmenting parameters via the user interface 500. For example, the user may enter a value of 600 for the maximum HP parameter to generate an augmenting parameter that increases the health of the paladin entity. In embodiments, the user interface 500 may provide a listing and/or graphical representation of options that are available to use as augmenting parameters. For example, upon selecting a color parameter, the user interface 500 may provide a listing of colors and/or a color wheel indicating the available colors that may be entered as an override parameter for the modified entity.

In embodiments, the user interface 500 may include an add parameter 506 option that enables a user to add a new parameter to the modified entity, as previously described. For example, the aura ability may be added as a new parameter for the paladin entity. Once the values for the augmenting parameters have been entered via the user interface 500, the user may then select the submission icon 508 to provide the augmenting parameters for generating the modified set of parameters to the augmenting parameter system. In embodiments, the user interface 500 may perform suitable type checking or other parameter validation checks, such as a debugging process, on entered values to ensure that the entered values are valid for each parameter field. Such parameter validation checks can be performed as the parameters are entered by a user and/or when the submission icon 508 is selected. For purposes of illustration and not limitation, such parameter validation checks could notify the user that the color “blue” is not a valid entry for the “Max HP” parameter field. Other such parameter validation checks are possible, and will depend on the specified type and allowable values, ranges, etc. of each parameter.

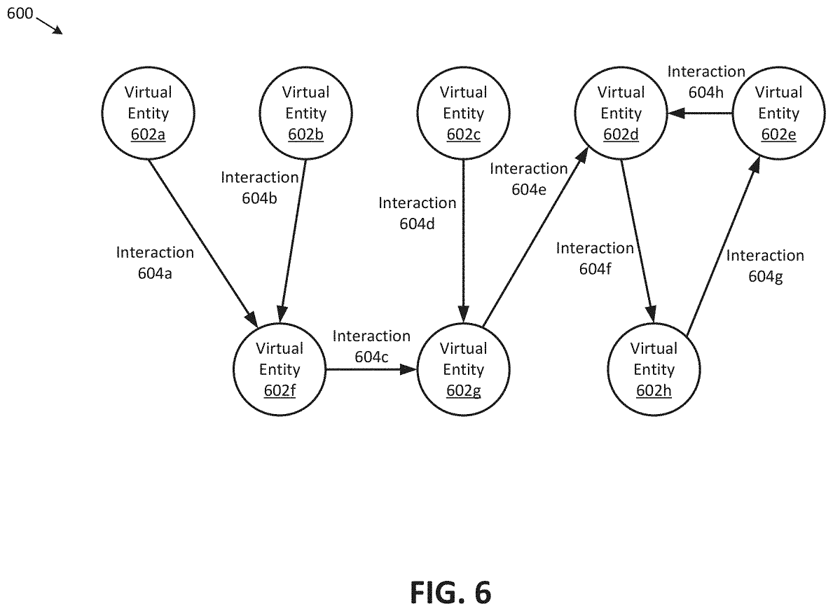

FIG. 6 is an illustration of an example of a simulation of a virtual environment 600 of a client application, in accordance with embodiments of the disclosure. Upon providing augmenting parameters, a user may wish to see the effects the modifications made to the entity have on a client application. For example, in a video game application, the user may wish to see if the augmenting parameters make a particular entity too powerful/weak. To do this, processing logic of the augmenting system may generate a simulation of a virtual environment 600 (also referred to as “simulation” hereafter) that allows the user to test/monitor the effects various augmenting parameters have on the virtual entities.

Referring to FIG. 6, the simulation may correspond to a simulation of a level of a video game application. The simulation may include virtual entities 602a-h that each correspond to a virtual entity within the simulation. Each of the virtual entities 602a-h may have a corresponding set of parameters, as previously described. The simulation may simulate various interactions 604a-h between virtual entities 602a-h. Interactions 604a-h may be any sort of action performed by the virtual entities 602a-h. For example, in a video game application, an interaction may be a virtual entity attacking another virtual entity, a virtual entity healing another virtual entity, a virtual entity defending another virtual entity, etc.

The simulation may be executed and interactions 604a-h may be performed by virtual entities 602a-h. Statistics associated with the simulation may be acquired based on the simulation. The statistics may correspond to parameters of the virtual entities 602a-h resulting from interactions 604a-h, values associated with the interactions 604a-h, or any other statistics associated with the simulation. For example, the statistics may correspond to a virtual entity's hit points following the performance of interactions 604a-h, the amount of damage dealt by one of interactions 604a-h that corresponds to an attack on a virtual entity, if a virtual entity was defeated during the simulation, if a particular team of virtual entities won the simulation, etc.

In embodiments, multiple instances of the simulation may be executed to acquire a larger sample size of statistical data. In some embodiments, each instance of the simulation may have the same interactions 604a-h between the virtual entities 602a-h. In embodiments, instances of the simulation may utilize different combinations of interactions between the virtual entities 602a-h. In some embodiments, the instances of the simulation may utilize different combinations of virtual entities 602a-h. In an embodiment, the multiple instances of the simulation may be executed for the same virtual environment of a client application. For example, the multiple instances of the simulation may be executed for a particular level of a video game application. In embodiments, the multiple instances of the simulation may be executed for different virtual environments of a client application. For example, the multiple instances of the simulation may be executed for multiple levels of a video game application.

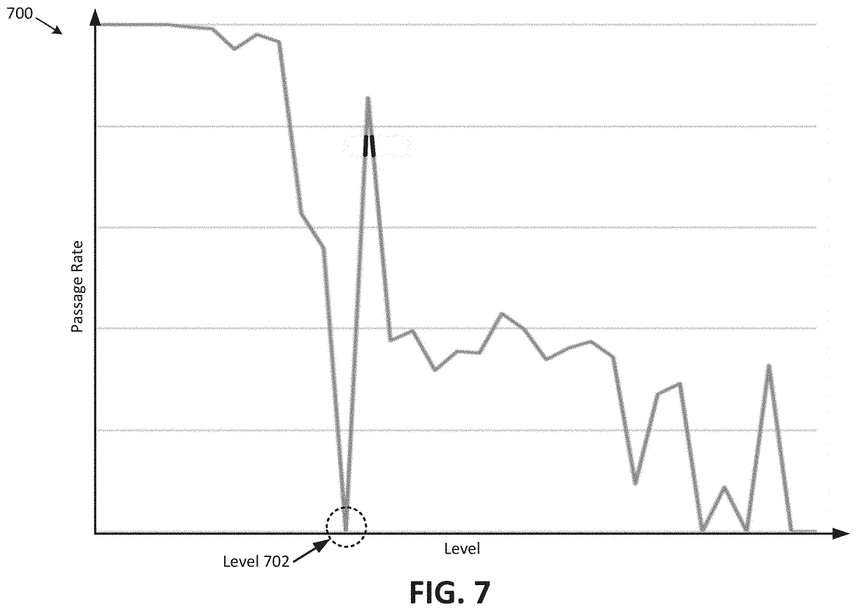

FIG. 7 is an illustration of an example of a graphical representation 700 of statistics acquired from a simulation of a client application, in accordance with embodiments of the disclosure. As previously described, statistics may be acquired from the execution of simulations of the virtual environment of a client application to determine the effects of augmenting parameters. Graphical representation 700 includes an X-axis that corresponds to levels of a video game application and a Y-axis that corresponds to the percentage passage rate for that particular level. For example, the X-axis may correspond to levels 1-20 of the video game application and the Y-axis may correspond to a 0-100% passage rate for a particular level.

In embodiments, the graphical representation 700 may be used by a developer to identify if the augmenting parameters have negatively/positively affected a user experience of a client application. For example, if the augmenting parameters cause the passage rate for each level of the video game application to be at or near 100%, then the augmenting parameters may have caused the game to become too easy and present less of a challenge to the player, negatively affecting the user experience. In another example, if the augmenting parameters cause the passage rate for each level of the video game application to be at or near 0%, then the augmenting parameters may have cause the game to become too difficult, also negatively affecting the user experience.

In the example scenario presented in the graphical representation 700, level 702 has a passage rate at or near 0% based on the execution of one or more instances of simulations of level 702. This may indicate that the augmenting parameters being used have made level 702 too difficult and should be changed. In some embodiments, a developer may change the augmenting parameters to increase the passage rate for level 702. In embodiments, processing logic of the augmenting parameter system may automatically adjust the augmenting parameters to meet a desired passage rate. For example, the processing logic may iteratively adjust the augmenting parameters and execute subsequent simulations until the passage rate for level 702 is at 15%.

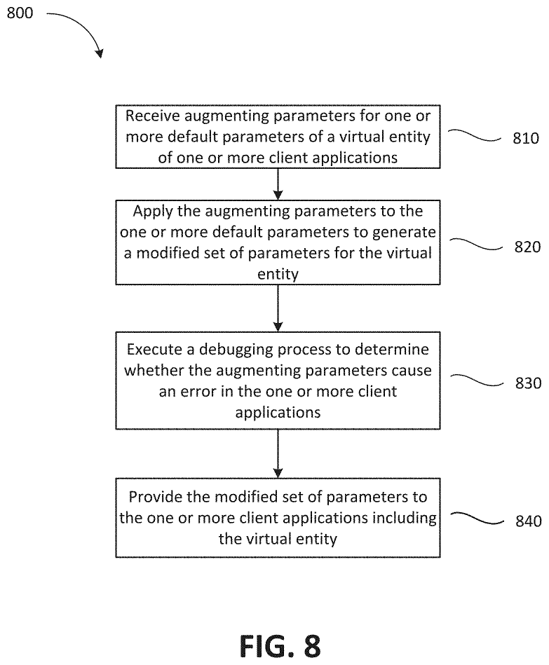

FIG. 8 is a block diagram illustrating an example method 800 of utilizing augmenting parameters to modify an entity of one or more client applications, in accordance with embodiments of the disclosure. In general, the method 800 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. For example, the processing logic may be implemented as parameter receiving component 121, parameter application component 122 and/or entity modification component 123.

Method 800 may begin at block 810, where the processing logic receives augmenting parameters for one or more default parameters of a virtual entity of one or more client applications. In embodiments, the one or more client applications may be video game applications. In some embodiments, the one or more client applications may be architectural modeling applications. In an embodiment, the one or more client applications may be computer animation and/or video editing applications. In embodiments, the one or more client applications may be mapping/navigation applications. In some embodiments, the one or more client applications may include a first application using a first programming language and a second application using a second programming language. For example, the one or more client applications may include a first client application using C++ and a second client application using Lua™.

At block 820, the processing logic applies the augmenting parameters to the one or more default parameters to generate a modified set of parameters for the virtual entity. As previously described, the processing logic may apply the augmenting parameters to the one or more default parameters and generate the modified set of parameters without modifying the underlying source code of the one or more client applications.

At block 830, the processing logic executes a debugging process to determine whether the augmenting parameters cause an error in the one or more client applications. As previously described, in some embodiments, a user/developer may provide augmenting parameters via a user interface of a simple script. If a user enters an invalid value for one of the augmenting parameters, or improperly modifies the simple script when generating the augmenting parameters, then the modifications may cause an error in one or more of the client applications. For example, if the developer modifies the parameter “Max HP” to read “Mx HP,” then the parameter may no longer be properly linked to the underlying code of the one or more client applications, resulting in an error. In embodiments, the processing logic may provide an identification of one or more of the augmenting parameters that caused the error in the one or more client applications to enable a developer to quickly identify/troubleshoot and augmenting parameters that are causing errors. For example, the processing logic may provide an identification of the augmenting parameter that reads “Mx HP” that causes an error in one or more of the client applications.

At block 840, the processing logic provides the modified set of parameters to the one or more client applications including the virtual entity. As previously described, in some embodiments the modified set of parameters may cause the one or more client applications to modify the virtual entity while the one or more client applications are running.

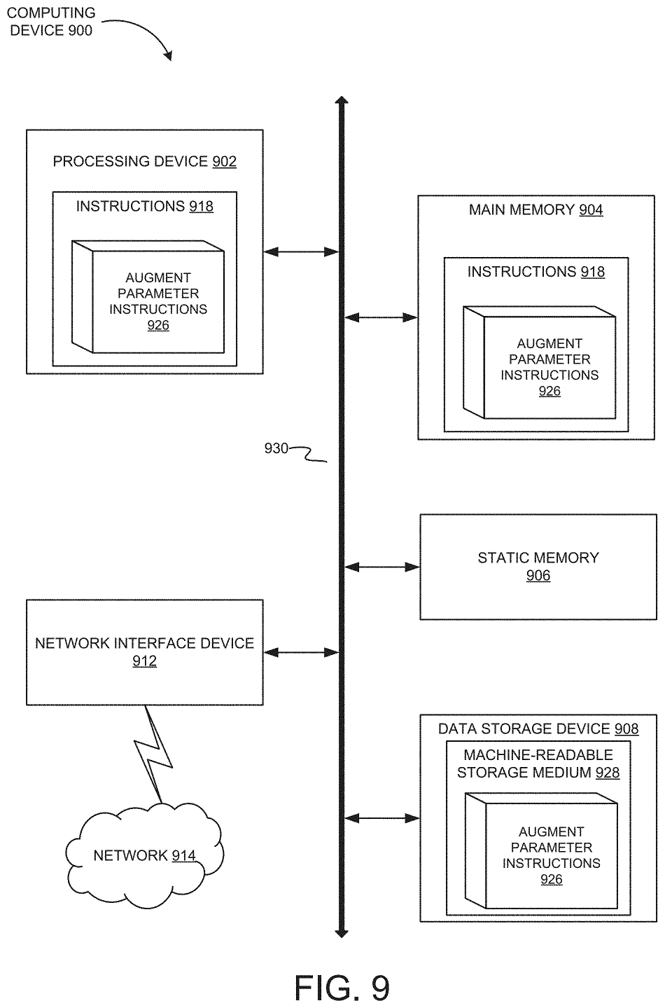

FIG. 9 is a block diagram of an example computing device 900 that may perform one or more of the operations described herein, in accordance with the present embodiments. The computing device 900 may be connected to other computing devices in a LAN, an intranet, an extranet, and/or the Internet. The computing device 900 may operate in the capacity of a server machine in client-server network environment or in the capacity of a client in a peer-to-peer network environment. The computing device 900 may be provided by a personal computer (PC), a set-top box (STB), a server, a network router, switch or bridge, or any machine capable of executing a set of instructions (sequential or otherwise) that specify actions to be taken by that machine. Further, while only a single computing device 900 is illustrated, the term “computing device” shall also be taken to include any collection of computing devices that individually or jointly execute a set (or multiple sets) of instructions to perform the methods discussed herein.

The example computing device 900 may include a computer processing device (e.g., a general purpose processor, ASIC, etc.) 902, a main memory 904, a static memory 906 (e.g., flash memory and a data storage device 908), which may communicate with each other via a bus 930. The computer processing device 902 may be provided by one or more general-purpose processing devices such as a microprocessor, central processing unit, or the like. In an illustrative example, computer processing device 902 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The computer processing device 902 may also comprise one or more special-purpose processing devices such as an application specific integrated circuit (ASIC), a field programmable gate array (FPGA), a digital signal processor (DSP), network processor, or the like. The computer processing device 902 may be configured to execute the operations described herein, in accordance with one or more aspects of the present disclosure, for performing the operations and steps discussed herein.

The computing device 900 may further include a network interface device 912, which may communicate with a network 914. The data storage device 908 may include a machine-readable storage medium 928 on which may be stored one or more sets of instructions, e.g., instructions for carrying out the operations described herein, in accordance with one or more aspects of the present disclosure. Instructions 918 implementing augment parameter instructions 926 may also reside, completely or at least partially, within main memory 904 and/or within computer processing device 902 during execution thereof by the computing device 900, main memory 904 and computer processing device 902 also constituting computer-readable media. The instructions may further be transmitted or received over the network 914 via the network interface device 912.

While machine-readable storage medium 928 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer processing device, a computer, a system on a chip, or multiple ones, or combinations, of the foregoing. A computer processing device may include one or more processors which can include special purpose logic circuitry, e.g., an FPGA (field programmable gate array) or an ASIC (application specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, or solid state drives. However, a computer need not have such devices. Moreover, a computer can be embedded in another device, e.g., a smart phone, a mobile audio or media player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method, comprising:
receiving augmenting parameters for one or more default parameters of a virtual entity of one or more client applications;
applying, by a computer processing device, the augmenting parameters to the one or more default parameters to generate a modified set of parameters for the virtual entity; and
providing the modified set of parameters to the one or more client applications comprising the virtual entity, wherein the virtual entity is modified based on the modified set of parameters while the one or more client applications is running.

2. The method of claim 1, wherein the augmenting parameters are applied to the one or more default parameters without modifying underlying code of the one or more client applications.

3. The method of claim 1, further comprising:
generating a simulation of the one or more client applications comprising the virtual entity that is modified based on the modified set of parameters.

4. The method of claim 3, further comprising:
executing one or more instances of the simulation of the one or more client applications comprising the virtual entity that is modified based on the modified set of parameters; and
generating one or more statistics for the one or more instances of the simulation.

5. The method of claim 1, further comprising:
executing a debugging process to determine whether the augmenting parameters cause an error in the one or more client applications; and
in response to the debugging process determining that the augmenting parameters cause the error in the one or more client applications, providing an identification of one or more of the augmenting parameters that caused the error in the one or more client applications.

6. The method of claim 1, further comprising:
generating a graphical user interface (GUI) comprising the default parameters of the virtual entity; and
receiving, via the GUI, the augmenting parameters for the one or more of the default parameters.

7. The method of claim 1, wherein the one or more client applications comprise a first client application using a first programming language and a second client application using a second programming language.

8. The method of claim 1, wherein the one or more default parameters are linked to underlying code of the one or more client applications.

9. The method of claim 1, wherein the augmenting parameters comprise a new ability to be added to the virtual entity of the one or more client applications.

10. A system, comprising:
a memory; and
a computer processing device, operatively coupled to the memory, to:
receive augmenting parameters for one or more default parameters of a virtual entity of one or more client applications;
apply the augmenting parameters to the one or more default parameters to generate a modified set of parameters for the virtual entity; and
provide the modified set of parameters to the one or more client applications comprising the virtual entity, wherein the virtual entity is modified based on the modified set of parameters while the one or more client applications is running.

11. The system of claim 10, wherein the augmenting parameters are applied to the one or more default parameters without modifying underlying code of the one or more client applications.

12. The system of claim 10, wherein the computer processing device is further to:
generate a simulation of the one or more client applications comprising the virtual entity that is modified based on the modified set of parameters.

13. The system of claim 12, wherein the computer processing device is further to:
execute one or more instances of the simulation of the one or more client applications comprising the virtual entity that is modified based on the modified set of parameters; and
generate one or more statistics for the one or more instances of the simulation.

14. The system of claim 10, wherein the computer processing device is further to:
execute a debugging process to determine whether the augmenting parameters cause an error in the one or more client applications; and
in response to the debugging process determining that the augmenting parameters cause the error in the one or more client applications, provide an identification of one or more of the augmenting parameters that caused the error in the one or more client applications.

15. The system of claim 10, wherein the computer processing device is further to:
generate a graphical user interface (GUI) comprising the default parameters of the virtual entity; and
receive, via the GUI, the augmenting parameters for the one or more of the default parameters.

16. The system of claim 10, wherein the one or more client applications comprise a first client application using a first programming language and a second client application using a second programming language.

17. The system of claim 10, wherein the one or more default parameters are linked to underlying code of the one or more client applications.

18. The system of claim 10, wherein the augmenting parameters comprise a new ability to be added to the virtual entity of the one or more client applications.

19. A non-transitory computer-readable medium having instructions stored thereon that, when executed by a computer processing device, cause the computer processing device to:
receive augmenting parameters for one or more default parameters of a virtual entity of one or more client applications;
apply, by the computer processing device, the augmenting parameters to the one or more default parameters to generate a modified set of parameters for the virtual entity; and
provide the modified set of parameters to the one or more client applications comprising the virtual entity, wherein the virtual entity is modified based on the modified set of parameters while the one or more client applications is running.

20. The non-transitory computer-readable medium of claim 19, wherein the computer processing device is further to:
generate a simulation of the one or more client applications comprising the virtual entity that is modified based on the modified set of parameters.
